(19) United States
(12) Patent Application Publication
(10) Pub. No.: US 2006/0188039 A1
(43) Pub. Date: Aug. 24, 2006

(54) Method and apparatus for performing an n-dimensional gradient search

(76) Inventors: Mark Alvis Wahl, Windsor, CO (US); Aaron Mathew Volz, Fort Collins, CO (US); Charles Everett Moore, Loveland, CO (US)

Correspondence Address: AVAGO TECHNOLOGIES, LTD., P.O. BOX 1920, DENVER, CO, 80201-1920, US

(21) Appl. No.: 11/062,149

(22) Filed: Feb. 18, 2005

(51) Int. Cl. H04L 27/06

(52) U.S. Cl. 375/340

(57) ABSTRACT

A method and apparatus is presented for performing an n-dimensional gradient search. A state machine is implemented to manage the initial location of the search, increment a counter used to count a search, generate locations (i.e., settings) of the search and the errors associated with the search. The state machine manages an n-dimensional counter. In one embodiment, a tertiary counter is implemented. The tertiary counter performs a three-state count and then rolls over to the beginning count at the end of the three states. The three-state count corresponds to a location of a search, a location of the search minus one, and a location of the search plus one.

### BACKGROUND OF THE INVENTION

1. Description of the Related Art

A variety of problems can be solved with search methods. One of these search methods is a gradient search method. A gradient search starts at a single location/setting (root) and then all locations/settings adjacent to the root are tested. The best adjacent location and/or setting then become the root and then the gradient search expands from there.

FIG. 1 displays a conventional x-y input filter. A control 112 generates an x-signal shown as 116 and a y-signal shown as 114. The x-signal 116 and the y-signal 114 are input into a filter 102. The filter 102 also receives analog input data 100. The x-signal 116 and the y-signal 114 are input into the filter 102 to control and filter the analog input data 100. The filter 102 outputs filtered data 104. The filtered data 104 serves as input to an error counter 106. The filtered data 104 is observed by the error counter 106 to generate an error count 108. The error count 108 is input into the control 112. A reset signal 110 may be used to reset the error counter 106 when a timer threshold is reached.

FIG. 2 displays a conventional error count diagram. The error count diagram of FIG. 2 will be discussed in conjunction with the x-y input filter shown in FIG. 1. The error count diagram of FIG. 2 may be used as part of a gradient search implementation. The error count diagram of FIG. 2 displays the error count for each x-signal 116 and y-signal 114 setting combination.

The root location 200 for the search is shown at coordinates X=1 and Y=1 (i.e., written as 1/1). The error count at the root location is 7. For the purposes of discussion, a nomenclature is defined. Throughout this disclosure, the x-signal (i.e., x value) is described as “setting_x” and the y-signal (i.e., y value) is described as “setting_y.” Therefore, x=1 is the same as setting_x=1 and y=1 is the same as setting_y=1. In addition, the y-component of the root location is described as “root_y” and the x-component of the root location is described as “root_x.” In the current example, root_x and root_y also both equal 1.

A gradient search checks all of the adjacent locations (i.e., x/y=0/0, 0/1, 0/2, 1/0, 1/1, 1/2, 2/0, 2/1, 2/2) to find the setting that produce the least amount of errors. In this example, the x/y location with the least errors is found at x=0, y=2 (i.e., 0/2) which has 0 errors.

Implementing the various search methods often requires complex software and/or hardware. As a result, the cost and time associated with performing these methods may be burdensome. Specifically, methods used to implement a gradient search may be complex, time consuming, and costly.

Thus, there is a need for a simple, cost effective method and apparatus for performing a gradient search.

### SUMMARY OF THE INVENTION

In accordance with the teachings of the present invention, a simple, cost effective method and apparatus for performing a gradient search is presented.

A search circuit, comprises a state machine managing state information for a gradient search; and an n-dimensional counter coupled to the state machine, the n-dimensional counter performing a count in n-dimensions in response to the state machine managing the state information.

A gradient search circuit comprises an increment signal; a rollover signal; and a first tertiary counter receiving the increment signal and generating the rollover signal in response to performing a three-state count.

A gradient search circuit comprises n counters, wherein each of the n counters performs a count associated with a dimension of a gradient search.

A method of performing a gradient search, comprises the steps of operating a state machine to generate state information; operating an n-dimensional counter to generate a count for each dimension of a search, the n dimensional counter comprising, n counters each generating the count for the dimension of the search; and performing an n-dimensional gradient search in response to operating the n-dimensional counter.

### BRIEF DESCRIPTION OF THE DRAWINGS

FIG. 1 displays a conventional x-y input filter implemented in accordance with the teachings of the present invention.

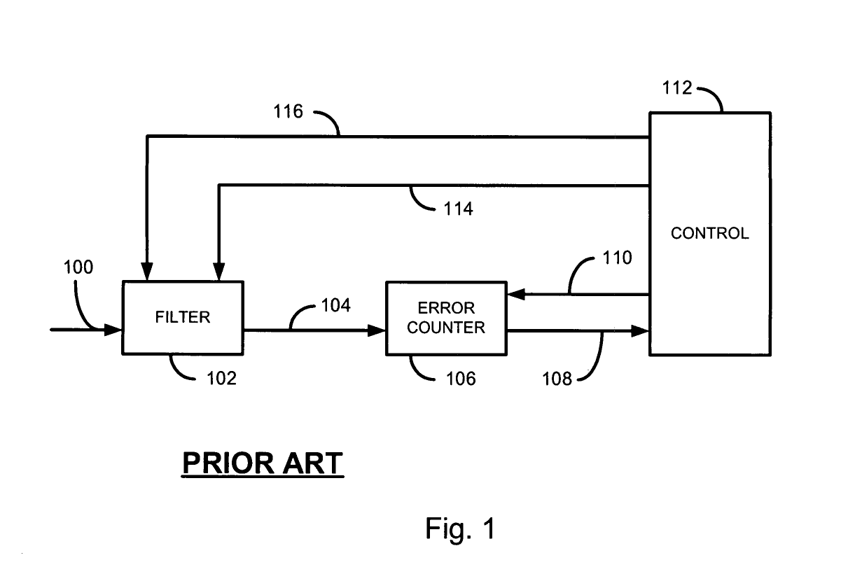

FIG. 2 displays a conventional error count diagram.

FIG. 3 displays a circuit implementing the teachings of the present invention.

FIG. 4 displays a filter implemented in accordance with the teachings of the present invention.

FIG. 5 displays a timing diagram and a counter implemented in accordance with the teachings of the present invention.

FIG. 6 displays a flow diagram implementing the teachings of the present invention.

FIG. 7 displays a circuit implementing another embodiment of the present invention.

FIG. 8 displays an n-dimensional counter implemented in accordance with the teachings of the present invention.

### DETAILED DESCRIPTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

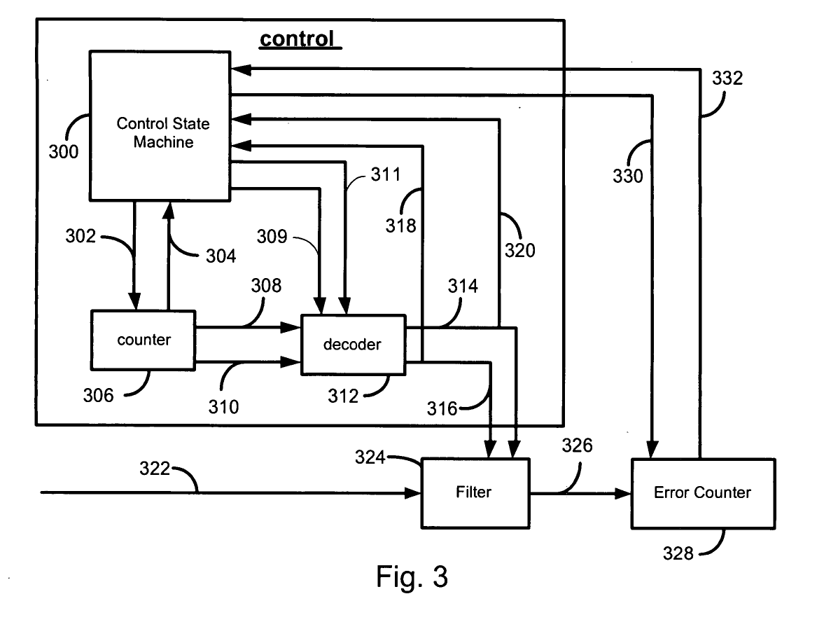

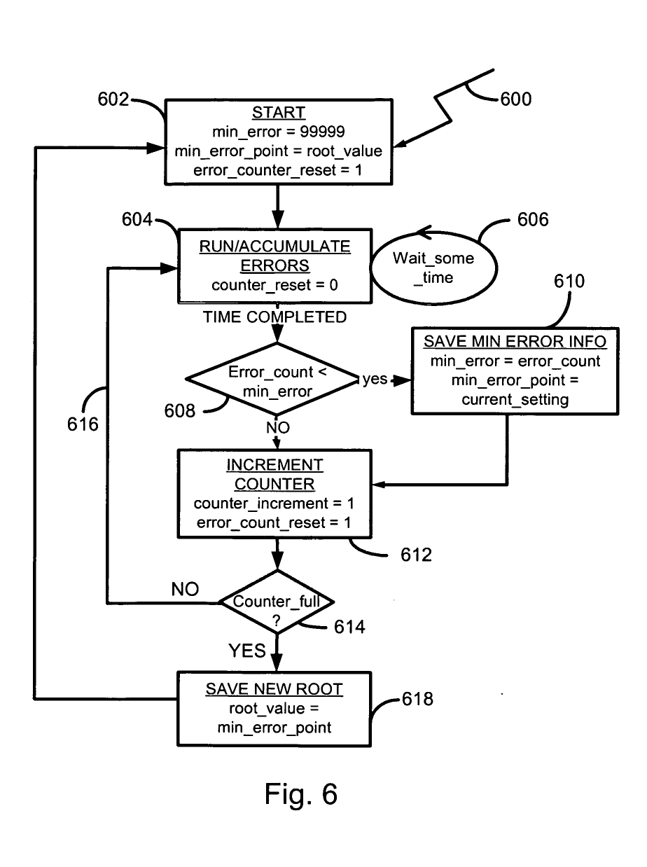

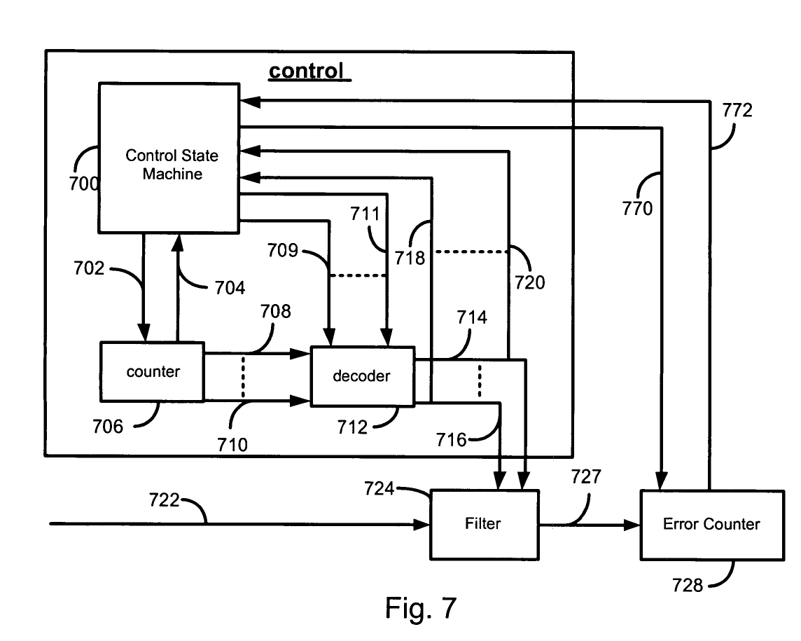

FIG. 3 displays a circuit implementing the teachings of the present invention. In one embodiment, the circuit is implemented to generate the x/y settings for a two-dimensional gradient search. In FIG. 3, the circuit is implemented as a two-bit tertiary counter with two bits per dimension, resulting in four bits. However, it should be appreciated that the general method and teachings of the present invention may be implemented to perform an n-dimensional search as detailed in FIG. 6 and FIG. 7.

In FIG. 3, a control state machine 300 is shown. The control state machine manages state information associated with a gradient search. The state information associated with the gradient search includes information necessary to coordinate and/or manage the search. In one embodiment, the state information includes counter incrementing information, counter full information, root location information, setting location information, error count information, counter reset information, etc. A counter_increment signal 302 is generated by the control state machine 300 and a counter_full signal 304 is received by the control state machine 300. A counter 306 is coupled to the control state machine 300 through the counter_increment signal 302 and the counter_full signal 304. The counter_increment signal 302 is received by the counter 306 and the counter_full signal 304 is generated by the counter 306. The counter 306 also generates a count_x signal 308 and a count_y signal 310. For example, the count_x signal 308 increments/decrements the x-coordinate of a search and the count_y signal 310 increments/decrements the y-coordinate of a search. In one embodiment, the count_x signal 308 and a count_y signal 310 are each implemented with 2 bits of data. In accordance with the teachings of the present invention, a two-dimensional gradient system includes 4 bits in the setting signals (i.e., count_x signal 308 and a count_y signal 310).

In one embodiment of the present invention, the counter 306 is implemented as a 4-bit tertiary dimensional counter. In a tertiary counter such as counter 306, the counter 306 has three count values that correspond to testing three different locations in a gradient search. The two Least-Significant-Bits (LSB) of the counter 306 count in the following manner: 00>01>10>00>01>10>. The two Most-Bits (MSB) of the dimensional counter follow the same incrementing style, but only increment when the two LSB transition from 10>00. The full count (i.e., two MSBs and the Two LSBs) is provided in Table 1:

TABLE I

| MSB | LSB |
|---|---|
| 00 | 00 |
| 00 | 01 |
| 00 | 10 |
| 01 | 00 |
| 01 | 01 |
| 01 | 10 |
| 10 | 00 |
| 10 | 01 |
| 10 | 10 |

The two MSB correspond to the count_x signal 308 and the two LSB correspond to the count_y signal 310.

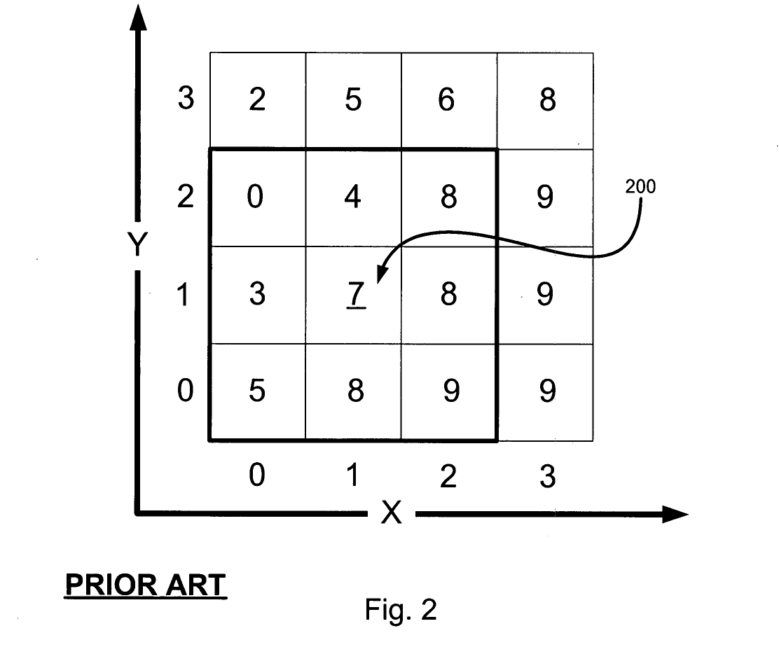

The count_x signal 308 and the count_y signal 310 serve as input to a decoder 312. A root_x signal 309 and a root_y signal 311 also serve as input to the decoder 312. The root_x signal 309 and the root_y signal 311 are the starting location for the gradient search (i.e., 1/1 in the example shown in FIG. 2). The root_x signal 309 is combined with the count_x signal 308 in the decoder 312 to generate setting_x signal 314 (i.e., output). The root_y signal 311 and count_y signal 310 are combined in the decoder 312 to generate setting_y 316 (i.e., output). The decoder 312 performs the following functions to generate the setting_x signal 314:

| count_x | function |
|---|---|
| 00 | setting_x = root_x |
| 01 | setting_x = root_x + 1 |
| 10 | setting_x = root_x − 1 |

The decoder 312 performs the following functions to generate the setting_y signal 316:

| count_y | function |
|---|---|
| 00 | setting_y = root_y |
| 01 | setting_y = root_y + 1 |
| 10 | setting_y = root_y − 1 |

Current setting_x 318 and current setting_y 320 are input into the control state machine 300. In a two-dimensional implementation, the setting_x 314 and a setting_y signal 316 correspond to an x-coordinate and a y-coordinate in an x-y coordinate system. The current setting_x 318 and current setting_y 320 are the current setting values at a specific clock cycle.

The setting_x signal 314 and the setting_y signal 316 are input into the filter 324 to filter an input signal 322. In one embodiment, the input signal 322 represents an analog input signal. The filter 324 outputs filtered data 326. The filtered data 326 serves as input to an error counter 328. The filtered data 326 is observed by the error counter 328 to generate an error count 332. The error count 332 is input into the control state machine 300. A counter_reset signal 330 may be used to reset the error counter 328 when a preset timer has expired.

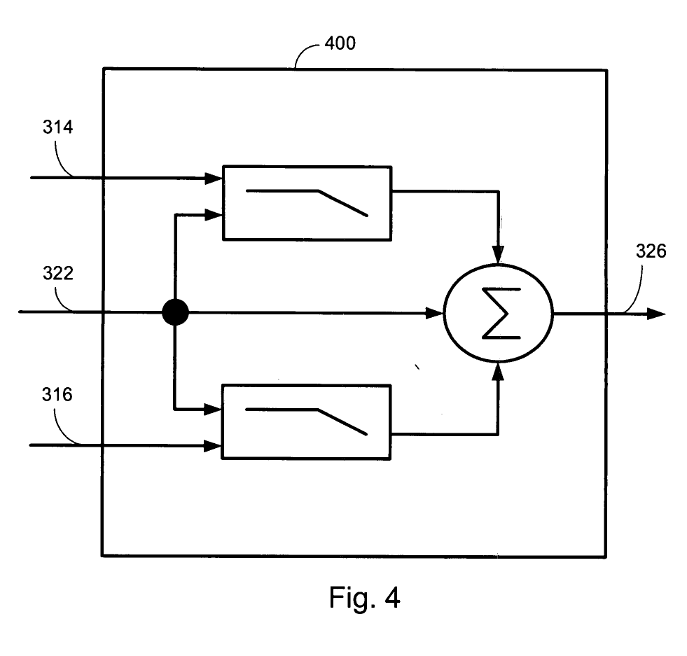

FIG. 4 displays a filter, such as the filter 324 of FIG. 3, implemented in accordance with the teachings of the present invention. The filter 400 receives the setting_x signal 314, the setting_y signal 316, and the input signal 322 as input. The filter 400 processes the input data and produces filtered data 326.

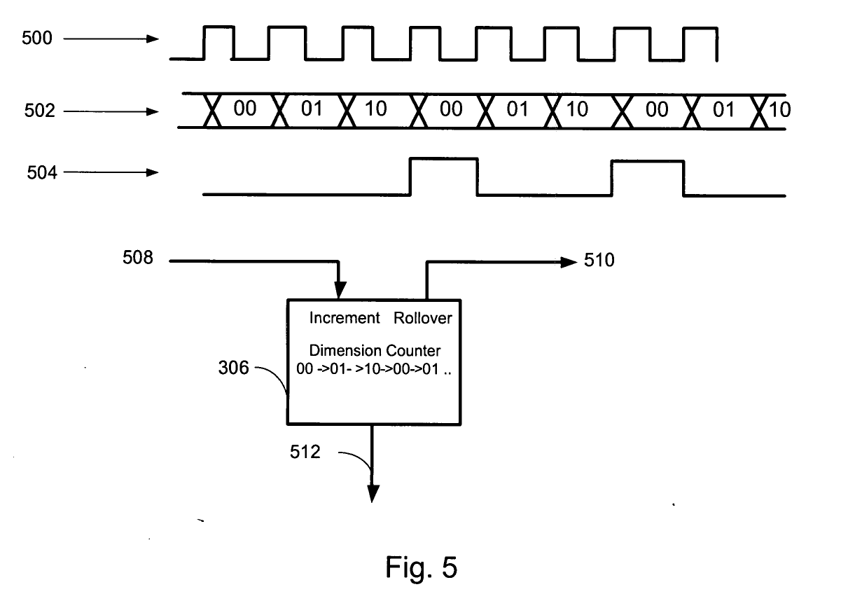

FIG. 5 displays a timing diagram and a counter implemented in accordance with the teachings of the present invention. In FIG. 5, dimensional counter 306 of FIG. 3 is shown. The counter 306 receives an increment signal 508 and generates a rollover signal 510. The counter 306 generates the count_n signal 512 (i.e., count_x signal 308 and count_y signal 310 of FIG. 3). A counter_increment (i.e., the counter increment signal corresponds to 508) signal is shown in the timing diagram as 500. A counter output signal (i.e., the counter output signal corresponds to 512) is shown in the timing diagram as 502, and a rollover signal (i.e., the rollover signal corresponds to 510) is shown in the timing diagram as 504. As shown, the rising edge of the counter_increment signal 500 causes the counter 306 to increment by one. When the counter 306 rolls over from 10>00, the rollover signal 510 is asserted.

FIG. 6 displays a flow diagram implementing the teachings of the present invention. For the purposes of discussion, FIG. 3 will be discussed in conjunction with FIG. 6. However, it should be appreciated that the method of FIG. 6 may be applied to any n-dimensional gradient search. A number of variables are defined. Root_value is implemented with the root_x signal 309 and the root_y signal 311 of FIG. 3. The min_error is equivalent to the minimum number of errors set for the gradient search. The min_error_point is the setting_x, setting_y point that resulted in the minimum number of errors.

At step 600, the gradient search begins with a root_value=0. As mentioned previously, in one embodiment, the root_value corresponds to the root_x signal 309 and the root_y signal 311 of FIG. 3. Therefore, when the root_value=0, the root_x signal 309 equals zero and the root_y signal 311 equals zero. The variable counter_reset (i.e., counter_reset signal 330 of FIG. 3) is asserted to reset the counter (i.e., 306 of FIG. 3) to zero. Counter_increment (i.e., counter_increment signal 302 of FIG. 3) is asserted to increment the counter (i.e., 306 of FIG. 3) by 1. Counter_settings refers to the counter settings, such as setting_x signal 314 and setting_y signal 316 of FIG. 3.

At the start 602, the min_error is set to a maximum value (i.e., 99999), the min_error_point is set to the root_value, and the error_counter_reset is set to 1. The system of FIG. 3 is run and errors are accumulated as stated at 604. The system of FIG. 3 is run until a preset timer expires. After some time as stated at 606, a test is made as stated at 608 to determine if the error_count is less than the min_error. If the error_count is less than the min_error, then the minimum error information is saved as stated at 610. Saving the minimum error information includes setting min_error=error_count and setting min_error_point=current_setting. If the error_count is not less than the min_error, then the counter is incremented as shown at 612. Incrementing the counter includes setting counter_increment=1 and error_count_reset=1. A test is then made to determine if the counter (i.e., 306 of FIG. 3) is full as stated at 614, which indicates that all points have been tested. As shown by the feedback loop 616, if the counter is not full, the process returns to run/accumulate errors 604. If the counter is full, then a new root is saved as shown at 618. Saving a new root includes setting root_value=min_error_point. After saving the new root 618, the process loops back to the start 602. It should be appreciated that the method and apparatus of the present invention may be implemented for adaptive tuning or continuous tuning. For example, the method of the present invention may be performed a single time to determine a best value or the method of the present invention may be performed continuously to adaptively identify the best value.

FIG. 7 displays a circuit implementing the teachings of the present invention. In one embodiment, the circuit is implemented to generate n-dimensional settings for a gradient search. In FIG. 7, the circuit is implemented with an n-dimensional counter and an n-dimensional decoder. In FIG. 7, a control state machine 700 is shown. A counter_increment signal 702 is generated by the control state machine 700 and a counter_full signal 704 is received by the control state machine 700. A counter 706 is coupled to the control state machine 700 through the counter_increment signal 702 and the counter_full signal 704. The counter_increment signal 702 is received by the counter 706 and the counter_full signal 704 is generated by the counter 706. The counter 706 also generates a count_{—}1 signal 708 and a count_n signal 710. In an n-dimensional implementation, the count_{—}1 signal 708 is implemented with 2 bits and the count_n signal 710 is implemented with 2 bits. For example, the count_{—}1 signal 708 may increment/decrement the x-coordinate of a search and the count_n signal 710 may increment/decrement the nth-coordinate of a search. In accordance with the teachings of the present invention, an n-dimensional gradient system includes 2n bits in the count signals (i.e., count_{—}1 signal 708, count_n signal 710, etc).

In one embodiment of the present invention, the counter 706 is implemented as a 2n-bit counter. There are a range of bits from the MSB (count_n) to the LSB (count_{—}1) that correlate with each dimension of the search. The two Least-Significant-Bits (LSB) of this counter count in the following manner: 00>01>10>00>01>10>00 . . . .As a result, the counter 706 is a tertiary counter, where three states are generated that correspond to three search locations in the gradient search. In one embodiment, each dimension of the counter is implemented with two bits. The next higher dimension of the counter follow the same incrementing style, but only increment when the two LSB transition from 10>00. The full count (i.e., two MSBs and the two LSBs) is provided in Table I:

TABLE I

| MSB | LSB |
|---|---|
| 00 | 00 |
| 00 | 01 |
| 00 | 10 |
| 01 | 00 |
| 01 | 01 |
| 01 | 10 |
| 10 | 00 |
| 10 | 01 |
| 10 | 10 |

The two MSB correspond to the count_n signal 710 and the two LSB correspond to the count_{—}1 signal 708.

The count_{—}1 signal 708 and a count_n signal 710 serve as input to a decoder 712. A root_{—}1 signal 709 and a root_n signal 711 also serve as input to the decoder 712. The root_{—}1 signal 709 and a root_n signal 711 are the starting location for the gradient search. The root_{—}1 signal 709 is combined with the count_{—}1 signal 708 in the decoder 712 to produce setting_{—}1 signal 714 (i.e., output). The root_n signal 711 and count_n signal 710 are combined in the decoder 712 to produce setting_n signal 716 (i.e., output). The decoder 712 performs the following functions to generate the setting_{—}1 signal 714:

| count_1 | function |
|---|---|
| 00 | setting_1 = root_1 |
| 01 | setting_1 = root_1 + 1 |
| 10 | setting_1 = root_1 − 1 |

The decoder 712 performs the following functions to generate the setting_n signal 716:

| count_n | function |
|---|---|
| 00 | setting_n = root_n |
| 01 | setting_n = root_n + 1 |
| 10 | setting_n = root_n − 1 |

Current setting_{—}1 and current setting_n 718 are input into the control state machine 700. The setting_{—}1 signal 708 and the setting_n signal 710 correspond to the coordinates for the dimensions of the search. The current setting_{—}1 720 and current setting_n 718 are the settings at a specific count value.

The setting_{—}1 signal 714 and the setting_n signal 716 are input into the filter 724 to control an input signal 722. In one embodiment, the input signal 722 represents an analog input signal. The filter 724 outputs filtered data 727. The filtered data 727 serves as input to an error counter 728. The filtered data 727 is observed by the error counter 728 to generate an error count 772. The error count 772 is input into the control state machine 700. A counter_reset signal 770 may be used to reset the error counter 728 when a preset timer threshold is reached.

In accordance with the teachings of the present invention, in an alternate embodiment, the counter can be extended beyond three states to any number of states. For example, a two-dimensional gradient search may be performed using a five state counter. In the five state counter, such as the counter 706 is implemented as a 2n-bit counter. There are a range of bits from the MSB (count_n) to the LSB (count_{—}1) that correlate with each dimension of the search. The two Least-Significant-Bits (LSB) of this counter count in the following manner: 000>001>010>011>100>000>001>010 >011>100 . . . . As a result, the counter 706 is a five-state counter, where five states are generated that correspond to five search locations in the gradient search. In one embodiment, each dimension of the counter is implemented with three bits. The next higher dimension of the counter follow the same incrementing style, but only increment when the two LSB transition from 100>000.

Using FIG. 7 to discuss one of the alternate embodiments, the count_{—}1 signal 708 and a count_n signal 710 serve as input to a decoder 712. A root_{—}1 signal 709 and a root_n signal 711 also serve as input to the decoder 712. The root_{—}1 signal 709 and a root_signal 711 are the starting location for the gradient search. The root_{—}1 signal 709 is combined with the count_{—}1 signal 708 in the decoder 712 to produce setting_{—}1 signal 714 (i.e., output). The root_n signal 711 and count_n signal 710 are combined in the decoder 712 to produce setting_n signal 716 (i.e., output). In the case of a five-state counter, the decoder 712 performs the following functions to generate the setting_{—}1 signal 714:

| count_1 | function |
|---|---|
| 000 | setting_1 = root_1 |
| 001 | setting_1 = root_1 + 1 |
| 010 | setting_1 = root_1 − 1 |
| 011 | setting_1 = root 1 + 2 |
| 100 | setting_1 = root_1 − 2 |

The decoder 712 performs the following functions to generate the setting_n signal 716:

| count_n | function |
|---|---|
| 000 | setting_n = root_n |
| 001 | setting_n = root_n + 1 |
| 010 | setting_n = root_n − 1 |
| 011 | setting_n = root_n + 2 |
| 100 | setting_n = root_n − 2 |

Current setting_{—}1 and current setting_n 718 are input into the control state machine 700. The setting_{—}1 signal 708 and the setting_n signal 710 correspond to the coordinates for the dimensions of the search. The current setting_{—}1 and current setting_718 are the settings at a specific count value.

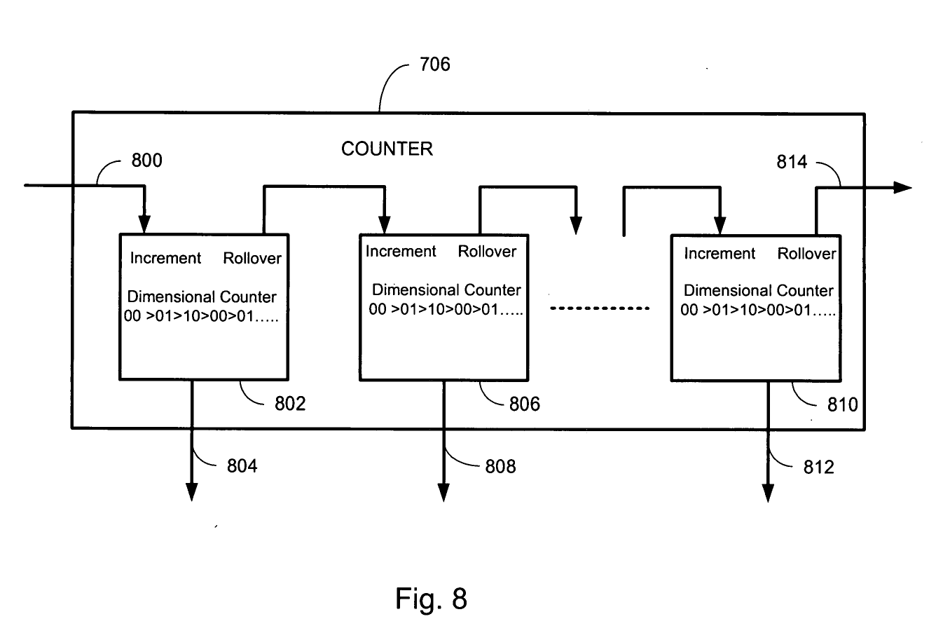

FIG. 8 displays an n-dimensional counter implemented in accordance with the teachings of the present invention. The counter 706 of FIG. 7 is implemented with the n-dimensional counter shown in FIG. 8. The counter 706 includes a counter_increment signal 800, which provides input to an n-dimensional counter 802. The counter 706 produces an output such as a count_{—}1 output 804, a count_{—}2 output 808, a count_n output 812, etc. The counter 706 includes n-dimensional counters 802, 806, and 810, which produce the count_{—}1 output 804, the count_{—}2 output 808, and the count_n output 812. The n-dimensional counter 810 is the last counter in the counter 706 and produces a counter_full output 814, when the counter 706 is full. The counter 706 includes a root_n, count_n, and setting_n for each dimension of the counter. In addition, there is a dimensional counter (i.e., 802, 806, 810, etc) for each dimension of the search.

Thus, the present invention has been described herein with reference to a particular embodiment for a particular application. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A search circuit, comprising:
a state machine managing state information for a gradient search; and
an n-dimensional counter coupled to the state machine, the n-dimensional counter performing a count in n-dimensions in response to the state machine managing the state information.

2. A search circuit as set forth in claim 1, wherein the search circuit is a gradient search circuit.

3. A search circuit as set forth in claim 1, further comprising a decoder coupled to the n-dimensional counter the decoder generating settings identifying locations for a gradient search in response to the count.

4. A search circuit as set forth in claim 1, wherein the n-dimensional counter is a two dimensional counter.

5. A search circuit as set forth in claim 1, wherein the n-dimensional counter is a tertiary counter.

6. A search circuit as set forth in claim 1, wherein the state information includes a counter increment signal for incrementing the counter.

7. A search circuit as set forth in claim 1, wherein the state information includes a root signal identifying an initial point of the gradient search.

8. A search circuit as set forth in claim 1, wherein the state information includes current settings of the gradient search.

9. A search circuit as set forth in claim 1, wherein the state information includes error count information identifying the number of errors.

10. A search circuit as set forth in claim 1, wherein the state information includes error counter reset information for resetting an error counter.

11. A search circuit as set forth in claim 1, wherein the count is a three state count.

12. A search circuit as set forth in claim 1, wherein the count is a three state count implemented with 00, 01, 10.

13. A search circuit as set forth in claim 1, wherein the count generates three locations for the gradient search, the three locations include a root location, a root +1 location, and a root −1 location, wherein the root location is a location of a search, the root +1 location is the location of a search plus 1 and the root −1 location is the location of a search minus 1.

14. A search circuit as set forth in claim 1, wherein the count is a five state count.

15. A search circuit as set forth in claim 1, wherein the count is a five state count implemented with 000, 001, 010, 011, and 100.

16. A search circuit as set forth in claim 1, wherein the count generates three locations for the gradient search, the three locations include a root location, a root +1 location, and a root −1 location, wherein the root location is a location of a search, the root+1 location is the location of a search plus 1, the root−1 location is the location of a search minus 1, the root+2 location is the location of a search plus 2 and the root−2 location is the location of a search minus 2.

17. A gradient search circuit, comprising:
an increment signal;
a rollover signal; and
a first tertiary counter receiving the increment signal and generating the rollover signal in response to performing a three-state count.

18. A gradient search circuit as set forth in claim 17, wherein there is a three-state count implemented as 00, 01, 10.

19. A gradient search circuit as set forth in claim 17, wherein the rollover signal is generated when count transitions are from 10 to 00.

20. A gradient search circuit as set forth in claim 17, wherein the three-state count corresponds to a search at a location defined by a root location, a root+1 location, and a root−1 location, wherein the root location is a location of a search, the root+1 location is the location of a search plus 1 and the root−1 location is the location of a search minus 1.

21. A gradient search circuit as set forth in claim 17, further comprising, a second tertiary counter receiving the rollover signal generated by the first tertiary counter and generating a second rollover signal in response to receiving the first rollover signal.

22. A gradient search circuit, comprising:
n counters, wherein each of the n counters performs a count associated with a dimension of a gradient search.

23. A gradient search circuit as set forth in claim 22, wherein the count is a tertiary count.

24. A gradient search circuit as set forth in claim 22, wherein the count is implemented with 00, 01 and 10.

25. A gradient search circuit as set forth in claim 22, wherein the is a three state count implemented with 00, 10 and 11 and wherein a rollover occurs when there is a transitions are from10 to 00.

26. A gradient search circuit as set forth in claim 22, wherein the count corresponds to a search at a location defined by a root location, a root+1 location, and a root−1 location, wherein the root location is a location of a search, the root+1 location is the location of a search plus 1 and the root−1 location is the location of a search minus 1.

27. A method of performing a gradient search, comprising the steps of:
operating a state machine to generate state information;
operating an n-dimensional counter to generate a count for each dimension of a search, the n dimensional counter comprising, n counters each generating the count for the dimension of the search; and
performing an n-dimensional gradient search in response to operating the n-dimensional counter.

28. A method of performing a gradient search, as set forth in claim 27 wherein each the step of operating the n-dimensional counter to generate a count further comprises the step operating the n-dimensional counter to generate a tertiary count.
